(19) United States
(12) Patent Application Publication
(10) Pub. No.: US 2013/0002721 A1
(43) Pub. Date: Jan. 3, 2013

(54) DISPLAY DEVICE, PORTABLE TERMINAL, METHOD FOR CONTROLLING THE DISPLAY DEVICE, AND PROGRAM PRODUCT

(75) Inventors: Naofumi Hirabayashi, Suwa-shi (JP); Makoto Takada, Matsumoto-shi (JP)

(73) Assignee: Seiko Epson Corporation, Tokyo (JP)

(21) Appl. No.: 13/533,323

(22) Filed: Jun. 26, 2012

(30) Foreign Application Priority Data
Jul. 1, 2011 (JP) 2011-147117

(51) Int. Cl. G09G 5/00

(52) U.S. Cl. 345/660; 345/672

(57) ABSTRACT

A display device includes: a display section for displaying, in an editing screen, a preview display region showing print data on a printing medium image; an operating section for specifying an arbitrary position in the preview display region; and a display control section for performing display control of the display section in accordance with operation performed by the operating section, wherein when image data in the print data is displayed in the preview display region and a display region of the image data in the preview display region is specified by the operating section, the display control section performs display control of the display section to display an image selection screen for selecting the type of the image data.

### CROSS-REFERENCE

The entire disclosure of Japanese Patent Application No. 2011-147117 filed on Jul. 1, 2011, which is hereby incorporated by reference in its entirety.

### BACKGROUND

In the past, as this type of display device, a label data generating apparatus formed of a personal computer, the label data generating apparatus that displays a label data editing screen and generates label data on the label data editing screen has been known (see Japanese Patent Publication No.2009-205599). In this label data generating apparatus, as the label data editing screen, a screen having an object creation area displaying a print image, a text insertion button for adding a text, a decorative frame insertion button for inserting a decorative frame, and an image insertion button for inserting an image is displayed. Moreover, when the image insertion button is clicked, an image selection screen for selecting various kinds of image data is displayed. Then, as a result of desired image data being selected on the image selection screen, various kinds of images are inserted.

Incidentally, making a portable terminal such as a smartphone start an application for creation of labels and function as a print data generating apparatus has been studied in recent years. In such a case, the existing configuration may be adopted to display the above-described label data editing screen as an editing screen and generate print data.

However, in the existing configuration, since there is a need to dispose the image insertion button for displaying the image selection screen, a screen layout is limited. In particular, in a device with a small display screen, such as the portable terminal described above, when the image insertion button is disposed, the image insertion button occupies a wide area on the display screen.

### SUMMARY

Various embodiments may provide a display device that can dispense with a button for displaying an image selection screen, a portable terminal, a method for controlling the display device, and a program product.

At least one embodiment of the disclosure, there is provided a display device including: a display section for displaying, in an editing screen, a preview display region showing print data on a printing medium image; an operating section for specifying an arbitrary position in the preview display region; and a display control section for performing display control of the display section in accordance with operation performed by the operating section, and, when image data in the print data is displayed in the preview display region and a display region of the image data in the preview display region is specified by the operating section, the display control section performs display control of the display section to display an image selection screen for selecting the type of the image data.

At least one embodiment of the disclosure, there is provided a method for controlling a display device including: (a) displaying, in an editing screen, a preview display region showing print data on a printing medium image, (b) acquiring positional information when an arbitrary position in the preview display region is specified, and controlling display of the editing screen based on the positional information, wherein, in the step (c), when image data in the print data is displayed in the preview display region and the positional information in a display region of the image data is acquired, display control is performed to display an image selection screen for selecting the type of the image data.

With these configurations, when the display region of the image data in the preview display region is specified, the image selection screen is displayed. This makes it possible to make the image data for confirmation of printing function as a button for displaying the image selection screen. Therefore, it is possible to dispense with a button for displaying the image selection screen. As a result, it is possible to alleviate the limitations on the screen layout and provide the user with more information on the editing screen in a device with a small display screen. For example, a screen layout such as disposing a button to which another function is assigned and displaying a status can be adopted.

In the display device described above, it is preferable that, when text data in the print data is displayed in the preview display region and a display region of the text data is specified by the operating section, the display control section performs display control of the display section to display a text editing screen for editing the text data.

With this configuration, it is possible to dispense with a button for displaying the text editing screen. This makes it possible to provide further alleviation of the limitations on the screen layout.

It is preferable that the display control section determines whether or not the image data in the print data is code image data, when a display region of the code image data is specified by the operating section, the display control section performs display control of the display section to display a code information editing screen for editing code information of the code image data, and, when a display region of image data other than the code image data is specified by the operating section, the display control section performs display control of the display section to display the image selection screen.

With this configuration, it is possible to dispense with a button for displaying the code information editing screen. This makes it possible to provide further alleviation of the limitations on the screen layout.

Moreover, it is preferable that, when a region other than the display region of the image data in the preview display region is specified by the operating section, the display control section performs display control of the display section to display the text editing screen.

With this configuration, when a region other than the display region of the image data is specified, the text editing screen with frequent edits is displayed. This makes it possible to provide a convenient interface.

It is preferable that the display control section regard a blank character as the text data.

With this configuration, since a blank character (space) is regarded as the text data, two pieces of text data with a space left between them can be recognized as one piece of text data. In addition, when a display region with a space is specified, the text editing screen can be displayed.

It is preferable that the display region of the text data be a rectangular region containing the text data.

With this configuration, since an area surrounding the displayed text data is set as the display region of the text data, the user easily specifies the display region of the text data. In addition, since a display region to be specified is a rectangular region, it is easy to set a display region.

On the other hand, it is preferable that the printing medium image be a tape image indicating a printing tape, and, when a predetermined region at a front or rear end of the tape image is specified by the operating section, the display control section performs display control of the display section to display a margin setting screen for setting a margin length at any one of front and rear ends or both of the front and rear ends of the print data.

With this configuration, it is possible to dispense with a button for displaying the margin setting screen. This makes it possible to provide further alleviation of the limitations on the screen layout.

In the display device described above, it is preferable that the display region of the image data be a rectangular region containing the image data.

With this configuration, since an area surrounding the displayed image data is set as the display region of the image data, the user easily specifies the display region of the image data. In addition, since a display region to be specified is a rectangular region, it is easy to set a display region.

In the display device described above, it is preferable that the display region of the image data be a region obtained by extending the outline of the image data, the region along the outline.

With this configuration, since an area surrounding the displayed image data is set as the display region of the image data, the user easily specifies the display region of the image data. Moreover, since a region along the outline of the image data is set as the display region of the image data, the user can easily recognize a display region.

At least one embodiment of the disclosure, there is provided a portable terminal including the display device described above and a transmitting section transmitting the print data edited by the editing screen to a printer.

With this configuration, it is possible to provide the user with more information on the editing screen in a portable terminal with a small screen.

At least one embodiment of the disclosure, there is provided a program product embodied in at least one computer readable medium and comprising computer instructions executable by a computer and making a computer perform the steps in the above-described method for controlling a display device.

With this configuration, only by installing the program product on a computer, it is possible to make the computer perform the above-described method for controlling a display device.

### BRIEF DESCRIPTION OF THE DRAWINGS

The invention will be described with reference to the accompanying drawings, wherein like reference numbers reference like elements.

FIG. 1 is a system configuration diagram of a printing system according to an embodiment of the invention.

FIG. 2 is a control block diagram of a portable terminal.

FIG. 3 is a functional block diagram of the portable terminal.

FIG. 4 is a diagram showing an editing screen.

FIG. 5 is a flowchart showing a screen transition operation.

FIG. 6 is an explanatory diagram showing the screen transition operation.

FIG. 7 is a diagram showing a modified example of a display region of symbol data.

### DESCRIPTION OF EXEMPLARY EMBODIMENTS

Hereinafter, a display device, a portable terminal, a method for controlling the display device, and a program product of the invention will be described with reference to the accompanying drawings. In this embodiment, a printing system including a portable terminal functioning as a display device and a tape printer is taken up as an example.

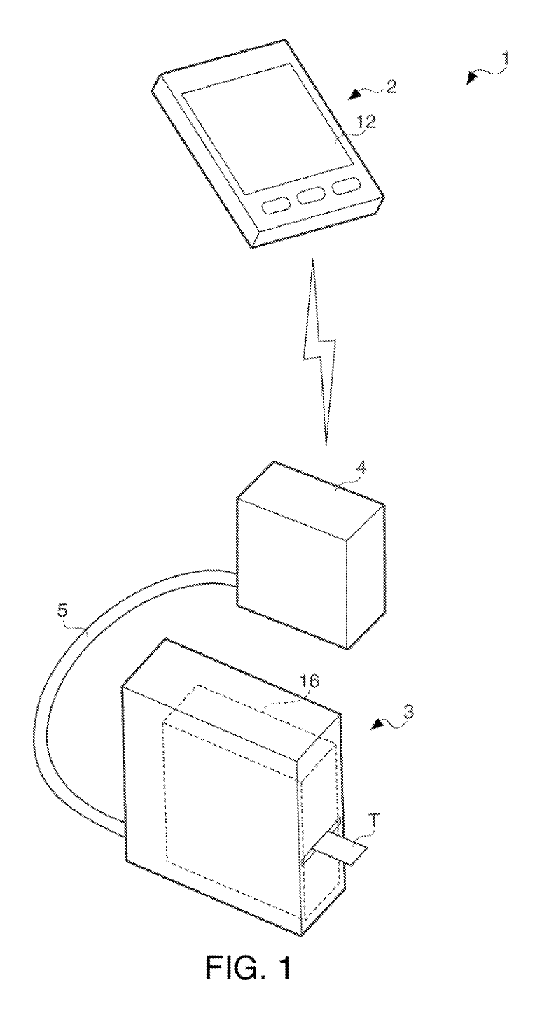

As shown in FIG. 1, a printing system 1 is formed of a portable terminal 2 on which an application for generation of print data is installed, a tape printer 3 printing, on a printing tape T, print data 62 generated on the portable terminal 2, and a wireless LAN (local area network) router 4. Of these component elements, wireless connection is established between the portable terminal 2 and the wireless LAN router 4, and the wireless LAN router 4 and the tape printer 3 are connected to each other with a cable 5. Incidentally, when the printing system 1 includes a plurality of portable terminals 2, the portable terminals 2 are allowed to use a single tape printer 3.

The portable terminal 2 is a common smartphone provided with a touch panel 12. In addition, by installing an application for generation of print data on the portable terminal 2 and starting the application, the portable terminal 2 functions as a print data generating apparatus that generates the print data 62.

A tape cartridge 16 housing a long printing tape T in such a way that the printing tape T can be unreeled therefrom is placed in the tape printer 3. The tape printer 3 creates a label by performing printing processing and cutting processing based on the print data 62 received from the portable terminal 2 while unreeling the printing tape T.

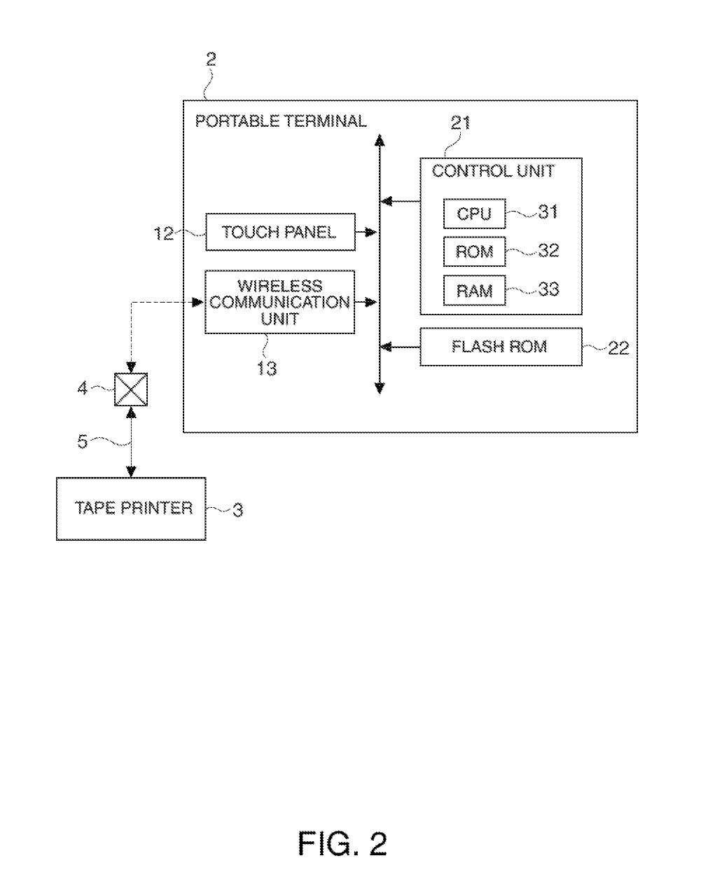

FIG. 2 is a control block diagram of the portable terminal 2. As shown in FIG. 2, the portable terminal 2 includes the above-described touch panel 12 which is a user interface, a wireless communication device 13 performing communication with the tape printer 3 via the wireless LAN router 4, a control unit 21 controlling these component elements, and flash ROM (flash read-only memory) 22 storing various kinds of data.

The control unit 21 is formed of a CPU (central processing unit) 31, ROM (read-only memory) 32, and RAM (random access memory) 33. The CPU 31 is a central processing unit and performs various kinds of computation processing. Incidentally, though not shown in the drawing, the CPU 31 has a timer for measuring the current time. The ROM 32 stores control program products used by the CPU 31 for performing various kinds of computation processing, and the RAM 33 is used as a work area used by the CPU 31 when the CPU 31 performs various kinds of computation processing. The flash ROM 22 stores various kinds of data of the tape printer 3 and stores an application for generation of print data.

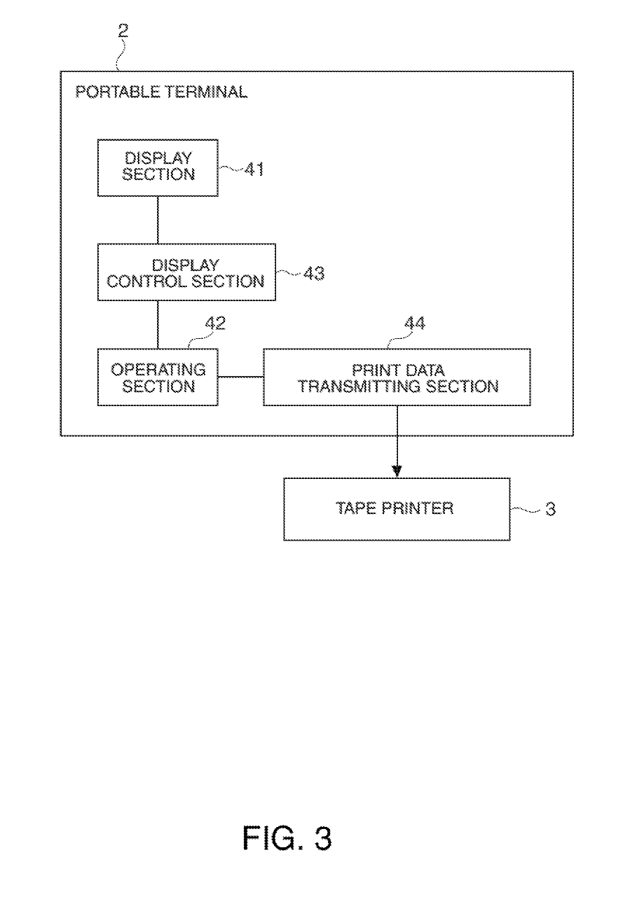

Here, the functional configuration of the portable terminal 2 will be described with reference to FIG. 3. As shown in FIG. 3, the portable terminal 2 includes a display section 41, an operating section 42, a display control section 43, and a print data transmitting section (a transmitting section) 44. The display section 41, whose principal portion is the touch panel 12, displays an editing screen A for generating and editing the print data 62. The operating section 42, whose principal portion is the touch panel 12, is a means for performing various kinds of operations on the editing screen A. The display control section 43, whose principal portion is the control unit 21, performs display control (display control of the editing screen A) of the display section 41 in accordance with an operation performed by the operating section 42. The print data transmitting section 44, whose principal portion is the wireless communication device 13, transmits the print data 62 edited by the editing screen A to the tape printer 3.

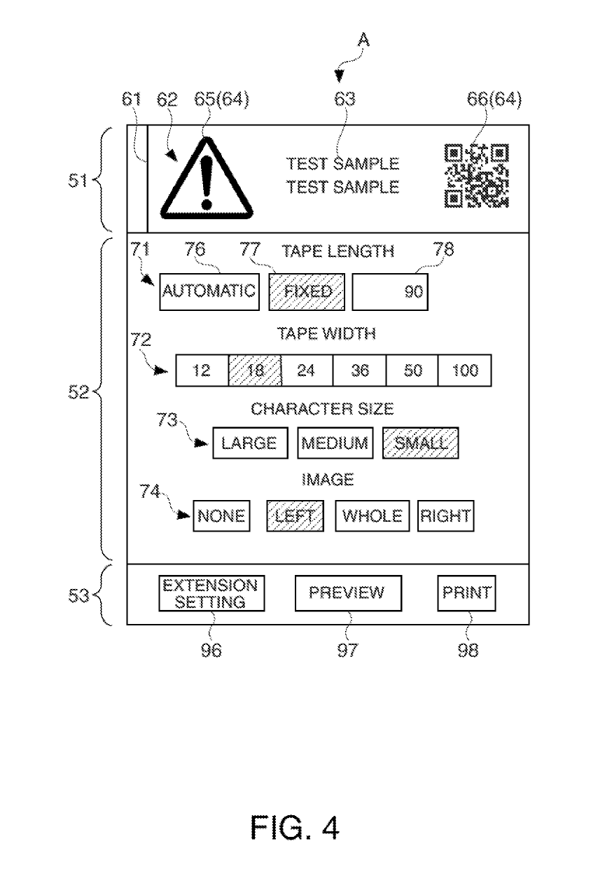

Next, the editing screen A will be described with reference to FIG. 4. The editing screen A has, from above, a preview display region 51, a menu display region 52, and an operation button display region 53.

The preview display region 51 displays the print data 62 disposed on a tape image (a printing medium image) 61 which is an image of the printing tape T in such a way that the print data 62 can be scrolled with a flick operation. The print data 62 has text data 63 inserted by means of the editing screen A and image data 64 inserted also by means of the editing screen A. Moreover, as the image data 64, there are code image data 66 indicating code information and image data 64 (hereinafter symbol data 65) other than the code image data 66. In an example shown in FIG. 4, the symbol data 65, the text data 63, and the code image data 66 are inserted and laid out in a line. Incidentally, as shown in FIG. 4, the code image data 66 is a two-dimensional code (here, a QR code). Moreover, as shown in FIG. 4, a blank character and a line feed character are also regarded as the text data 63.

In the menu display region 52, from above, a tape length setting menu 71, a tape width setting menu 72, a character size setting menu 73, and an image setting menu 74 are displayed.

The tape length setting menu 71 has a tape length automatic setting button 76 for automatically setting the tape length of the print data 62, a tape length fixed setting button 77 for manually setting the tape length at a fixed value, and a text box 78 into which a tape length is entered at the time of manual setting. The portable terminal 2 sets a tape length based on the print data 62 when tap operation is performed on the tape length automatic setting button 76 . On the other hand, when tap operation is performed on the tape length fixed setting button 77, entry into the text box 78 is enabled, and the print data 62 is edited in such a way that the print data 62 has an entered tape length (by, for example, addition of a margin and change of a character size and a character width).

The tape width setting menu 72 allows the tape width of the print data 62 to be selected from “12 mm”, “18 mm”, “24 mm”, “36 mm”, “50 mm”, and “100 mm”.

The character size setting menu 73 allows the character size of the text data 63 to be selected from “large”, “medium”, and “small”.

The image setting menu 74 allows a position into which the symbol data 65 is to be inserted to be selected from “none”, “left”, “whole region”, and “right”. Here, when “left” is selected, the symbol data 65 is disposed in a position closer to the left (disposed on the front end side of the tape). Moreover, when “right” is selected, the symbol data 65 is disposed in a position closer to the right (disposed on the rear end side of the tape). Furthermore, when “whole region” is selected, the symbol data 65 enlarged in a tape width direction is disposed in the whole region of the printing tape T. Incidentally, when the symbol data 65 is not inserted, by selecting “left” or “right” from the image setting menu 74, it is possible to insert a predetermined symbol data 65. In such a case, the predetermined symbol data 65 may be previously selected symbol data 65 or previously determined symbol data 65. Moreover, an image selection screen for selecting symbol data 65 may be displayed.

The operation button display region 53 has an extension setting button 96, a preview button 97, and a print button 98. The extension setting button 96 is a button for displaying an extension setting screen. In the extension setting screen, an image selection button for displaying the image selection screen, a QR code generation button for displaying a QR code generation screen for generating a QR code, and the like are displayed (not shown). The preview button 97 is a button for displaying a preview screen in which the print data 62 printed on the tape is displayed in actual size. The print button 98 is a button for providing a printing instruction. That is, with the press of the print button 98, the print data transmitting section 44 transmits the print data 62 to the tape printer 3.

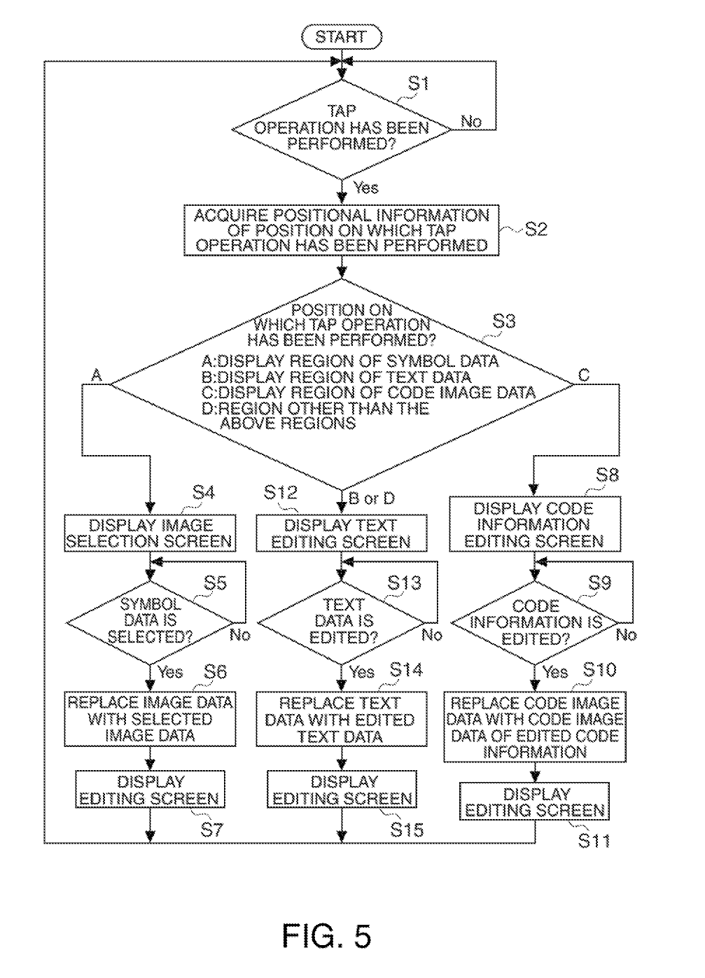

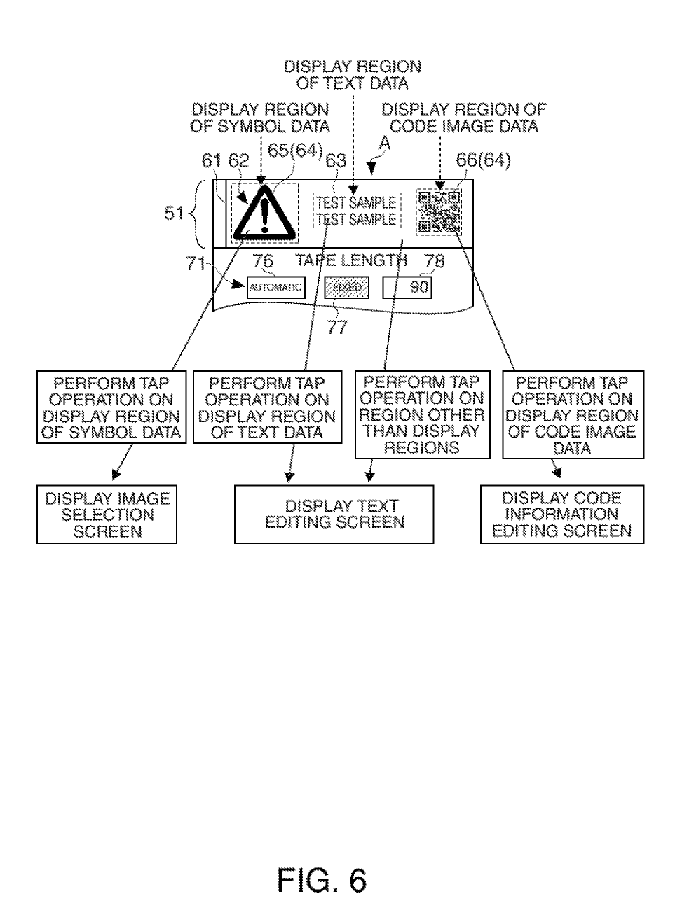

Incidentally, in this embodiment, to enhance the usability of the portable terminal 2, when tap operation is performed on the image data 64 or the text data 63 while the image data 64 and the text data 63 are displayed in the preview display region 51, the screen transitions to a selection screen or an editing screen for changing or editing these data. Here, with reference to FIGS. 5 and 6, a screen transition operation associated with the tap operation performed on the preview display region 51 will be described. FIG. 5 is a flowchart showing a screen transition operation. FIG. 6 is a screen transition diagram showing the screen transition operation. Incidentally, it is assumed that the screen transition operation is performed in a state in which the editing screen A is displayed. Moreover, in FIG. 6, a case in which the symbol data 65, the text data 63, and the code image data 66 are displayed in the preview display region 51 is shown as an example. Furthermore, in this embodiment, the screen is made to transition to another screen when tap operation is performed on the preview display region 51 of the editing screen A, and the screen is not made to transition to another screen when tap operation is performed on the preview screen.

As shown in FIG. 5, in the screen transition operation, in an initial state, it is determined whether or not tap operation has been performed on the preview display region 51 (S1). If tap operation has been performed on an arbitrary position in the preview display region 51 (when an arbitrary position in the preview display region 51 has been specified) (S1: Yes), the positional information of the position on which tap operation has been performed is acquired by the operating section 42 (S2: positional information acquisition step). When the positional information of the position on which tap operation has been performed is acquired, it is determined whether the position on which tap operation has been performed is a display region of the symbol data 65, a display region of the text data 63, a display region of the code image data 66, or a region other than these display regions based on the positional information (S3). In other words, it is determined whether the positional information in the display region of the symbol data 65 has been acquired, the positional information in the display region of the text data 63 has been acquired, the positional information in the display region of the code image data 66 has been acquired, or the positional information in a region in the preview display region 51, the region outside the above-described display regions, has been acquired. As shown in FIG. 6, in the portable terminal 2, a rectangular region containing the symbol data 65 is set as the display region of the symbol data 65, a rectangular region containing the text data 63 is set as the display region of the text data 63, and a rectangular region containing the code image data 66 is set as the display region of the code image data 66.

When the symbol data 65 is displayed in the preview display region 51 and it is determined that tap operation has been performed on the display region of the symbol data 65 in the preview display region 51 (S3: A), the image selection screen is displayed in the display section 41 by the display control section 43 (S4: display control step). The image selection screen is a screen for selecting the type of the image data 64. Specifically, the image selection screen is a screen for selecting any one piece of symbol data 65 from a plurality of previously stored pieces of symbol data 65. When one piece of symbol data 65 is selected by the operating section 42 (S5: Yes), the original symbol data 65 on which tap operation has been performed is replaced with the selected symbol data 65 of an image (S6). Then, the editing screen A is displayed (S7), and the state goes back to a tap operation wait state (S1).

On the other hand, when the code image data 66 is displayed in the preview display region 51 and it is determined that tap operation has been performed on the display region of the code image data 66 in the preview display region 51, a code information editing screen is displayed in the display section 41 by the display control section 43 (S8). The code information editing screen is a screen for editing the code information of the code image data 66. When the code information is edited by the operating section 42 (S9: Yes), the original code image data 66 on which tap operation has been performed is replaced with the code image data 66 of the edited code information (S10). Then, the editing screen A is displayed (S11), and the state goes back to a tap operation wait state (S1).

Furthermore, when the text data 63 is displayed in the preview display region 51 and it is determined that tap operation has been performed on the display region of the text data 63 in the preview display region 51 (S3: B) or when it is determined that tap operation has been performed on a region other than the above display regions (S3: D), a text editing screen is displayed in the display section 41 by the display control section 43 (S12). Though not shown in the drawing, the text editing screen is a screen for editing the text data 63 and is a screen having a character entry area in which the text data 63 which is being edited is displayed, a soft keyboard used for entering a character, and a candidate area in which predictive conversion candidates are illustrated. When the text is edited by the operating section 42 (S13: Yes), the original text data 63 on which tap operation has been performed is replaced with the edited text data 63 (S14). Then, the editing screen A is displayed (S15), and the state goes back to a tap operation wait state (S1).

With the configuration described above, the editing screen A can dispense with a button for displaying the image selection screen. This makes it possible to alleviate the limitations on the screen layout and provide the user with more information on the editing screen A in a device with a small display screen.

Moreover, by displaying the text editing screen when the display region of the text data 63 is specified by the operating section 42, the editing screen A can dispense with a button for displaying the text editing screen. This makes it possible to provide further alleviation of the limitations on the screen layout.

Furthermore, it is determined whether or not the image data 64 in the print data 62 is the code image data 66, and, when the display region of the code image data 66 is specified by the operating section 42, the code information editing screen is displayed; when the display region of the image data 64 (the symbol data 65) other than the code image data 66 is specified by the operating section 42, the image selection screen is displayed. As a result, the editing screen A can dispense with a button for displaying the code information editing screen. This makes it possible to provide further alleviation of the limitations on the screen layout.

Furthermore, when a region other than the display region of the image data 64 is specified, the text editing screen with frequent edits is displayed. This makes it possible to provide a convenient interface.

Moreover, since an area surrounding the displayed text data 63 is set as the display region of the text data 63, the user easily specifies the display region of the text data 63. In addition, since a display region to be specified is a rectangular region, it is easy to set a display region.

Furthermore, since an area surrounding the displayed image data 64 is set as the display region of the image data 64, the user easily specifies the display region of the image data 64. Moreover, since a display region to be specified is a rectangular region, it is easy to set a display region.

Moreover, since a blank character (space) and a line feed character are regarded as the text data 63, two pieces of text data 63 with a space left between them and the text data 63 into which a line feed is inserted can be recognized as one piece of text data 63. In addition, it is possible to display the text editing screen when a display region with a space is specified.

Incidentally, in this embodiment, when tap operation is performed on a predetermined region at a front or rear end of the tape image 61 by the operating section 42 (a predetermined region at a front or rear end of the tape image 61 is specified by the operating section 42), a margin setting screen for setting a margin length at any one of front and rear ends or both of the front and rear ends of the print data 62 may be displayed. In such a case, it is possible to dispense with a button for displaying the margin setting screen, making it possible to provide further alleviation of the limitations on the screen layout.

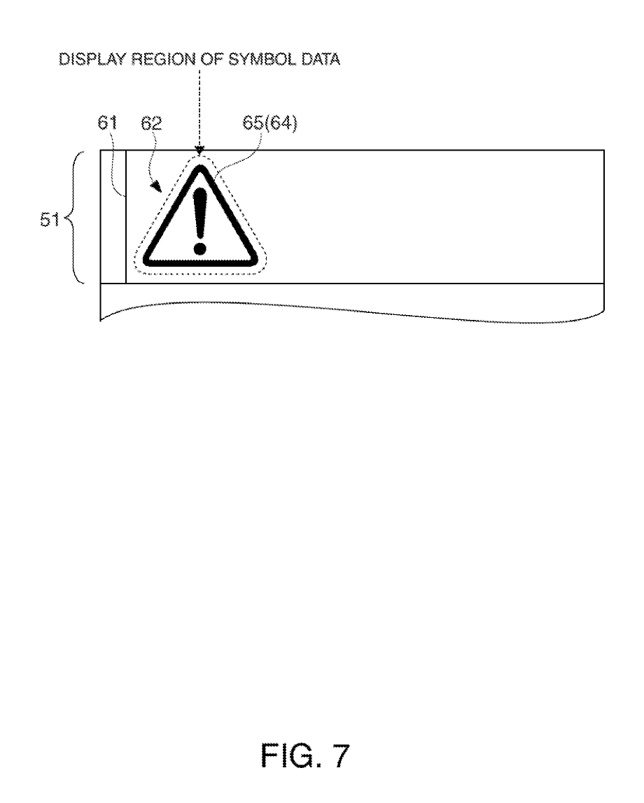

Moreover, in this embodiment, the rectangular region containing the image data 64 (the symbol data 65 and the code image data 66) is set as the display region of the image data 64. However, as shown in FIG. 7, a region obtained by extending the outline of the image data 64 (in FIG. 7, the symbol data 65), the region along the outline, may be set as the display region of the image data 64. In this case, the user can easily recognize a display region.

Furthermore, in this embodiment, as the code image data 66, the QR code is used as the print data 62. However, a two-dimensional code other than a bar code and a QR code may be used as the print data 62.

Moreover, in this embodiment, when tap operation is performed on the display region of each data in the preview display region 51 of the editing screen A, a corresponding selection screen or a corresponding editing screen is displayed. Instead, when tap operation is performed on the display region of each data on the preview screen (the printing confirmation screen) which is displayed as a result of tap operation being performed on the preview button 97, a corresponding selection screen or a corresponding editing screen may be displayed.

Furthermore, in this embodiment, any one of the image data 64 and the text data 63 or both are inserted, tap operation is performed on any one of the inserted image data 64 and text data 63 or both in the preview display region 51, and a selection screen or an editing screen for any one of the image data 64 and the text data 63 or both is displayed. By doing so, the above data is changed or edited. Instead, the portable terminal 2 may insert any one of sample image data 64 and sample text data 63 or both into the print data 62 in an initial state before editing. In this case, since any one of the image data 64 and the text data 63 or both are displayed in the preview display region 51 in an initial state, it is possible to generate print data 62 containing any one of the image data 64 and the text data 63 or both only with operation in the preview display region 51 and avoid the trouble of performing data insertion.

Moreover, in this embodiment, the invention is applied to a device generating the print data 62 of the tape printer 3. However, the invention may be applied to a device generating the print data 62 of a printer performing printing processing on a printing medium (for example, printing paper) which is not the printing tape T.

Furthermore, in this embodiment, the invention is applied to display control of the editing screen A by which the print data 62 is edited on the portable terminal 2. However, the invention may be applied to display control of the editing screen A by which the print data 62 is edited on a computer (for example, a personal computer) or display control of the editing screen A by which the print data 62 is edited on a tape printer 3.

Moreover, the invention may be applied to display control of the editing screen A by which inscription data of a Braille printer is edited. In this case, when tap operation is performed on a display region of Braille data in the inscription data on the preview display screen 51 displaying the inscription data, a Braille data editing screen for editing the Braille data may be displayed.

What is claimed is:

1. A display device comprising:
a display section for displaying, in an editing screen, a preview display region showing print data on a printing medium image;
an operating section for specifying an arbitrary position in the preview display region; and
a display control section for performing display control of the display section in accordance with operation performed by the operating section,
wherein
when image data in the print data is displayed in the preview display region and a display region of the image data in the preview display region is specified by the operating section, the display control section performs display control of the display section to display an image selection screen for selecting the type of the image data.

2. The display device according to claim 1, wherein
when text data in the print data is displayed in the preview display region and a display region of the text data is specified by the operating section, the display control section performs display control of the display section to display a text editing screen for editing the text data.

3. The display device according to claim 1, wherein
the display control section determines whether or not the image data in the print data is code image data,
when a display region of the code image data is specified by the operating section, the display control section performs display control of the display section to display a code information editing screen for editing code information of the code image data, and
when a display region of image data other than the code image data is specified by the operating section, the display control section performs display control of the display section to display the image selection screen.

4. The display device according to claim 1, wherein
when a region other than the display region of the image data in the preview display region is specified by the operating section, the display control section performs display control of the display section to display the text editing screen.

5. The display device according to claim 2, wherein
the display control section regards a blank character as the text data.

6. The display device according to claim 2, wherein
the display region of the text data is a rectangular region containing the text data.

7. The display device according to claim 1, wherein
the printing medium image is a tape image indicating a printing tape, and
when a predetermined region at a front or rear end of the tape image is specified by the operating section, the display control section performs display control of the display section to display a margin setting screen for setting a margin length at any one of front and rear ends or both of the front and rear ends of the print data.

8. The display device according to claim 1, wherein
the display region of the image data is a rectangular region containing the image data.

9. The display device according to claim 1, wherein
the display region of the image data is a region obtained by extending the outline of the image data, the region along the outline.

10. A portable terminal comprising:
the display device according to claim 1; and
a transmitting section transmitting the print data edited by the editing screen to a printer.

11. A method for controlling a display device comprising:
(a) displaying, in an editing screen, a preview display region showing print data on a printing medium image,
(b) acquiring positional information when an arbitrary position in the preview display region is specified, and
(c) controlling display of the editing screen based on the positional information,
wherein in step (c), when image data in the print data is displayed in the preview display region and the positional information in a display region of the image data is acquired, display control is performed to display an image selection screen for selecting the type of the image data.

12. A program product embodied in at least one non-transitory computer readable medium and comprising computer instructions executable by a computer and making a computer perform the method for controlling a display device according to claim 11.

13. A display device comprising:
a display section for displaying, in an editing screen, a preview display region showing print data on a printing medium image; and
an operating section for specifying an arbitrary position in the preview display region,
wherein
when image data in the print data is displayed in the preview display region and a display region of the image data in the preview display region is specified by the operating section, the display section displays an image selection screen for selecting the type of the image data.

14. The display device according to claim 13, wherein
when text data in the print data is displayed in the preview display region and a display region of the text data is specified by the operating section, the display section displays a text editing screen for editing the text data.

15. The display device according to claim 13, wherein
when the image data in the print data is code image data and a display region of the code image data is specified by the operating section, the display section displays a code information editing screen for editing code information of the code image data, and
when a display region of image data other than the code image data is specified by the operating section, the display section displays the image selection screen.

16. The display device according to claim 13, wherein
when a region other than the display region of the image data in the preview display region is specified by the operating section, the display section displays the text editing screen.

17. The display device according to claim 13, wherein
the printing medium image is a tape image indicating a printing tape, and
when a predetermined region at a front or rear end of the tape image is specified by the operating section, the display section displays a margin setting screen for setting a margin length at any one of front and rear ends or both of the front and rear ends of the print data.
